(19) United States
(12) Patent Application Publication
(10) Pub. No.: US 2018/0270299 A1
(43) Pub. Date: Sep. 20, 2018

(54) SYSTEM AND METHOD FOR PRODUCING API-THROTTLE AND BACK-PRESSURE AVOIDANCE AMONG CLIENTS USING DISTRIBUTED ASYNCHRONOUS COMPONENTS

(71) Applicant: FUGUE, INC., Frederick, MD (US)

(72) Inventors: Nathaniel S. MCCOURTNEY, Frederick, MD (US); Michael LIN, Frederick, MD (US)

(73) Assignee: FUGUE, INC., Frederick, MD (US)

(21) Appl. No.: 15/461,044

(22) Filed: Mar. 16, 2017

(51) Int. Cl. H04L 29/08; H04L 12/24; H04L 12/26; G06F 9/44

(52) U.S. Cl. CPC H04L 67/101; H04L 41/5096; G06F 9/4443; H04L 43/0882; H04L 43/16; H04L 67/1097

(57) ABSTRACT

A method for building, optimizing, and maintaining a computing infrastructure on a cloud computing environment is provided. A user provides a high-level declaration to a cloud environment operating system, specifying the details of the infrastructure that is intended to be built on the cloud. A cloud environment operating system converts the high level declaration to a lower level declaration and then to a series of instructions that can be executed by the cloud to build the desired infrastructure. The instructions can be sent to an API of a cloud service provider for execution. In order to avoid tripping an API throttle limit imposed by the cloud service provider, the cloud operating system can send a pre-determined number of commands to the API at any given time so as to avoid having the commands rejected due to exceeding the API throttle.

### FIELD OF THE INVENTION

This disclosure relates generally to cloud based computing environments in which a user is able to specify a desired infrastructure using a programming language configured to interface with a cloud environment operating system (OS). The cloud OS can then interface with a cloud-based service provider to create the desired infrastructure on the designated cloud computing environment.

### BACKGROUND OF THE INVENTION

Cloud computing allows individuals, businesses, and other organizations to implement and run large and complex computing environments without having to invest in the physical hardware (such as a server or local computer) necessary to maintain such environments. Rather than having to keep and maintain physical machines that perform the tasks associated with the desired computing environment, an end-user can instead “outsource” the computing to a computing “cloud” that can implement the desired computing environment in a remote location. The cloud can consist of a network of remote servers hosted on the internet that are shared by numerous end-users to implement each of their desired computing needs. Simplifying the process to build, optimize, and maintain computing environments on the cloud can lead to a positive end-user experience. Allowing a user to develop a robust computing infrastructure on the cloud, while seamlessly optimizing and maintain it, can minimize frustrations associated with corrupted infrastructure that can occur during the course of operating a computing environment on the cloud.

Many cloud service providers limit the number of commands that an individual user can send to the cloud to perform various tasks such as building infrastructure. The limit can be intended to ensure that a single user does not cause service issues for other customers who are also utilizing the cloud service to build and maintain their computing infrastructure. The limit can take the form of an application protocol interface throttle (“API throttle”). If an individual user exceeds the API throttle threshold, the system may “punish” the user by severely restricting the number of commands that the user can issue to the cloud service for a pre-determined amount of time. The user however, does not have a priori knowledge of what the throttling limit is, and may only learn that they have exceeded the limit when they experience the inevitable slowdown in their execution of their commands associated with the cloud service provider “punishing” them by severely restricting the number of commands they can process during a given time period. A cloud operating system that can ensure that a user never crosses the API throttling limit can ensure that the user is provided with a consistent experience in building and maintain computing infrastructure on the cloud via the cloud operating system.

### SUMMARY OF THE INVENTION

This disclosure relates to a cloud environment operating system that can process a user's cloud requests while at the same time ensuring that the user of the cloud operating system never crosses the cloud service provider's API throttling limit thereby ensuring that the user has a consistent service with minimal delays in implementing commands to build and maintain computing infrastructure.

The cloud operating system can have a pre-determined maximum number of commands that a user can send to the cloud service provider at any given time. The pre-determined maximum can be empirically determined and can be set so as to ensure that a user is virtually certain to never exceed a given cloud service provider's API throttle maximum.

### BRIEF DESCRIPTION OF THE DRAWINGS

FIG. 1 illustrates an exemplary cloud computing environment according to examples of the disclosure.

FIG. 2 illustrates an exemplary user cloud based computing environment design process according to examples of the disclosure.

FIG. 3 illustrates an exemplary computing environment infrastructure according to examples of the disclosure.

FIG. 4 illustrates an exemplary cloud environment operating system process according to examples of the disclosure.

FIG. 5 illustrates an exemplary cloud environment operating system functional block diagram according to examples of the disclosure.

FIG. 6 illustrates an exemplary planning module process according to examples of the disclosure.

FIG. 7 illustrates an exemplary infrastructure maintenance process according to examples of the disclosure.

FIG. 8 illustrates an exemplary builder/driver unit according to examples of the disclosure.

FIG. 9 illustrates an exemplary infrastructure building process according to examples of the disclosure.

FIG. 10 illustrates an exemplary cloud operating system queuing system according to examples of the disclosure.

FIG. 11 illustrates an example of a computing device in accordance with one embodiment.

### DETAILED DESCRIPTION OF THE INVENTION

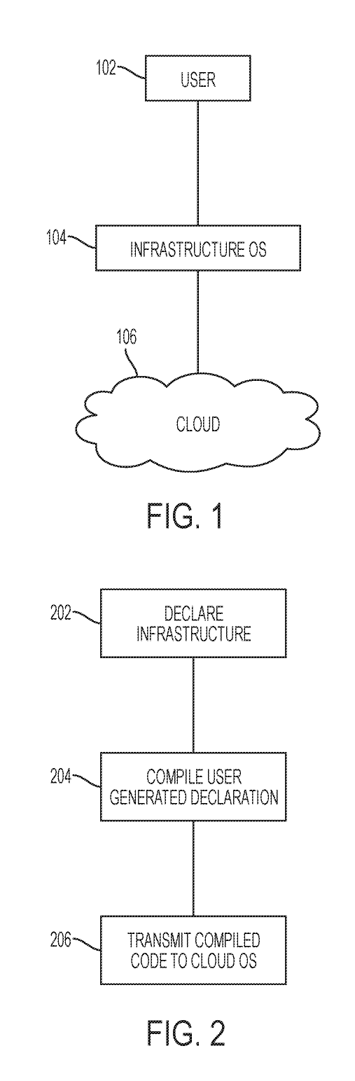

A cloud computing system (“cloud”) is a large distributed computer that is shared by multiple clients and is used to virtualize computing environments thereby liberating end-users from the burdens of having to build and maintain physical information technology infrastructure at a local site. FIG. 1 illustrates an exemplary cloud computing environment according to examples of the disclosure. The cloud computing environment depicted in FIG. 1 begins with a user 102 who wishes to implement a computing environment on a cloud 106. Examples of users 100 can include individuals, businesses, or other organizations that wish to utilize the distributed computer provided by the cloud to implement a computing environment such as a web server, a computer network, a computer database operation, etc.

The cloud 106, as previously discussed, is one or more distributed generalized computers that provide the computing resources to a user to allow them to implement their desired computing environment. Commercial cloud computing services such as Amazon™ web services, Microsoft Azure™, Google Cloud Platform™, are examples of distributed computer networks (clouds) available to users (for a fee) that allow them to build and host applications and websites, store and analyze data, among other uses. Clouds are scalable, meaning that the computing resources of the cloud can be increased or decreased based on the real-time needs of a particular user. In one example, a cloud 104 can be utilized to implement a website run by a user 102. The cloud 106 can maintain and operate a web-server based on the specifications defined by the user 102. As web-traffic to the website increases, the cloud can increase the computing resources dedicated to the website to match the surge in traffic. When web traffic is sparse, the cloud 106 can decrease the computing resources dedicated to the website to match the decrease in traffic. Cloud service providers can implement computing environments in “user accounts,” maintained and operated by the cloud service provider. Thus the computing environment of a first user can be implemented in a first user account, while the computing environment of a second user can be implemented in a second account. In some embodiments, a single user can maintain separate accounts for separate computing environments that they wish to implement and maintain. A Cloud Service Provider offers the infrastructure services that allow users to implement infrastructure “environments” in their CSP user accounts through those infrastructure services. For example, the VPC AWS Service allows one to create, modify, and delete a VPC.

An cloud environment operating system (OS) 104 can help to facilitate the interaction between a user 102 and a cloud computing environment 106. A conventional operating system manages the resources and services of a single computer. In contrast, an cloud environment operating system manages the resources and services of a cloud.

An cloud environment operating system can automate the creation and operation of one or more cloud infrastructures and can create and destroy computing instances on one or more cloud service providers. While the example of FIG. 1 illustrates the cloud environment operating system as a stand-alone entity, the example should not be considered limiting. The cloud environment operating system can be run on a client device, one a server such as a third party server, or located on a cloud service provider system that runs and executes the computing environment. The cloud environment operating system operates separately and interfaces with the cloud computing environment including any command line interfaces or operating systems used by the cloud to build and maintain the computing infrastructure.

An cloud environment operating system 104 can interface with a user 102 by allowing the user to specify a desired computing infrastructure in a simplified and concise manner. In one example, a user 102 can specify a computing environment using a programming language designed to interface with the cloud environment operating system 104. FIG. 2 illustrates an exemplary user cloud based computing environment design process according to examples of the disclosure. The example of FIG. 2 utilizes a programming language that once compiled can be inputted into the cloud environment operating system 104 for further processing.

At step 202 a user can provide a declaration of the infrastructure to be built on the cloud service provider. As an example, the user, using a pre-defined programming language, can specify the components within the infrastructure, the specifications of each component, and the types of communication that each component within the infrastructure has with each other.

In one example, at step 202, a user can provide a declaration of the infrastructure to be built on the cloud service provider utilizing a domain-specific programming language configured to allow a user to express infrastructure elements and relationships concisely in a text-based format. In additional examples, the domain-specific language can allow for comments to be expressed in-line with other content, thus allowing for the understanding and maintenance of content over time. Additionally, the domain specific-language can include pre-defined concepts (i.e., service types) that can enable the user of the cloud environment operating system to reference or use the concepts without having to define them themselves. Additionally, the domain specific language can allow for a user to define their own types, functions, and modules if desired. In some examples, the domain-specific language can include pre-defined libraries that can encompass definitions of cloud infrastructure elements, which can allow for code reuse, and thus reduce overall development effort. Finally, in one or more of the examples described above, the domain-specific language described above can be run through a compile, so as to identify problems in the user's specification of the cloud computing environment. This can lead to shorter feedback cycles, that can potentially be reduce costs by ascertaining problems with a cloud computing environment specification before consuming or instantiating a cloud-based service to develop computing infrastructure.

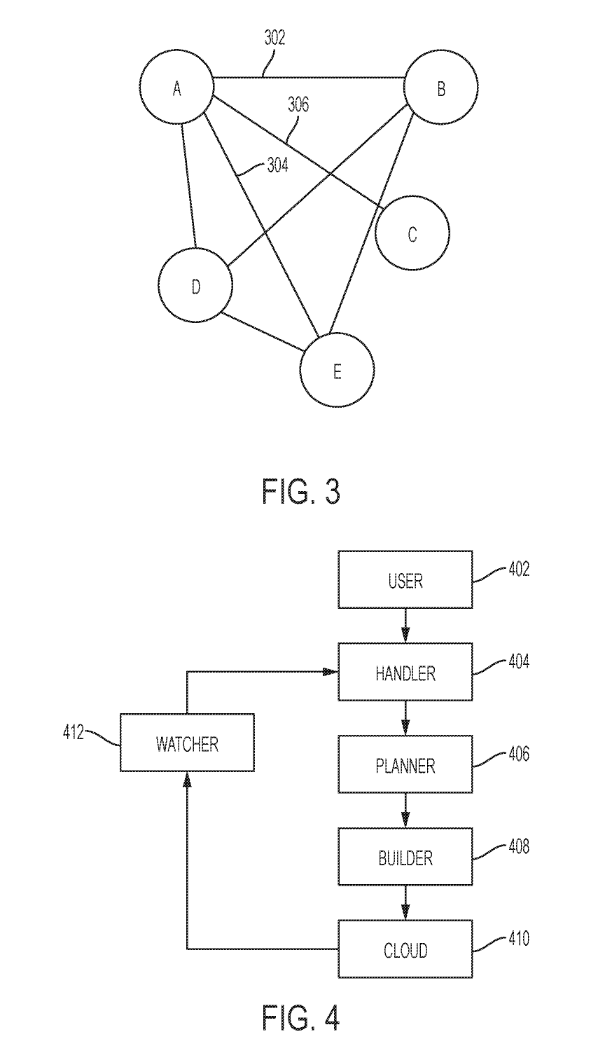

FIG. 3 illustrates an exemplary computing environment infrastructure according to examples of the disclosure. As illustrated in FIG. 3, each component of the computer infrastructure (labeled A-E) can be communicatively couple to other components that are part of the infrastructure. In one example component A could be a load balancer, component B could be a server, and component E a database. Components A, B, and E can be communicatively coupled to each other via one or more communication paths labeled 302, 304, and 306.

Referring back to FIG. 2, at step 202 a user can define each and every component of the computer infrastructure. In the example discussed above with respect to FIG. 3, a user can define the load balancer A, the server B, and the database E using the syntax of the programming language. The user 102 can provide specifications for each and every component of the infrastructure and can provide information about which components can communicate with one another (i.e., paths 302, 304, and 306) and also what type of communication will occur between the components.

At step 204, the user's declarations generated at step 202 can be compiled. The compiler can include multiple libraries that provide meaning to the declarations that the user generated at step 202. For instance the libraries can include information about the cloud environment operating system cloud environment operating system that is to be accessed, the cloud service on which the infrastructure is to be build (i.e., Google, Amazon, Microsoft) and information about the different components that can be created using the programming language.

Finally, at step 206, the compiled program code can be sent to the cloud environment operating system 104 for further processing. In some examples, the code compiled at step 204 and transmitted at step 206 is not a complete program ready to be executed by the cloud 106, but rather can be a code that contains numerous omissions to be later filled in by the cloud environment operating system 104. These “omissions” can be later be parsed by the cloud environment operating system and resolved based on the cloud service provider that is to be used in implementing the computing infrastructure. The compiled program code generated at step 204 can contain a terse, machine-friendly, but less user-friendly syntax. In this way, the programming language used in the example of FIG. 2 can allow a user to specify their infrastructure in a convenient easy-to-use syntax, but that syntax can then be converted into a machine-friendly syntax that can be parsed and used by a cloud environment operating system.

The syntax used by the programming language can be generic. In other words the syntax does not have to be tailored to work with any particular cloud service provider such as Amazon, Google, etc. Instead, a user can specify generic infrastructure and the cloud environment operating system as further discussed below can implement the generic declaration into a series of instructions that are understood by the cloud service provider being utilized. In some embodiments, the cloud environment operating system can determine which cloud service provider to implement the infrastructure on based on the specification of the infrastructure provided by the user. Referring back to FIG. 3, a user can specify a communication path between component A and component C; however that declaration does not have to take into account the cloud service that is to be ultimately utilized. Instead, the cloud environment operating system can translate the declaration of a communication path between component A and component C into a set of instructions that is to be understood by the utilized cloud service provider.

A user can also declare the infrastructure in a syntax that is germane to the cloud service provider that is ultimately be utilized. For instance, if a user knows that they want to utilize Microsoft's Azure platform, the user can generate declarations of the communication path between A and C in a syntax that is specific to the Azure cloud platform.

In addition to creating infrastructure for a cloud, the user can also save previously created infrastructures as libraries within the coding platform. In one example, if a user in the past created a database server infrastructure, they can save that infrastructure as a library. Then in the future, if the user wishes to create a computing environment that utilizes a database server, rather than create a new database server, the user can simply call upon the library in which the database server infrastructure is already stored and utilize it in the computing environment that is currently being created. In this way, the user can define re-usable infrastructure that can be applied to the creation of future infrastructure on a cloud based computing platform.

FIG. 4 illustrates an exemplary cloud environment operating system process according to examples of the disclosure. At step 402, a user can create a composition that describes the computing infrastructure that they want to build in the cloud. As discussed above, the composition can be written in the form of a declaration which is written in a domain specific programming language. Also as discussed above, once the user writes the composition, it can be translated into a hardware-friendly language that is compatible with the cloud environment operating system that will process the composition to generate the desired infrastructure.

At step 404 the composition generated by the user can be sent to a handler. The handler can capture and version the composition and determine if the composition drafted by the user is a new build (i.e., generating a new computer infrastructure from scratch) or an update to a previously existing infrastructure already running on the cloud. Once the handler receives the composition and makes the determinations described above, it can then trigger the build process by sending the composition to a planning stage.

At step 406, the composition can be passed from the handler stage to planner stage wherein the composition generated by the user is run through a series of modules (described in further detail below) that convert it into a series of instructions to be sent to a builder that will ultimately build the infrastructure in the cloud. The planner stage in addition to interpreting the language of the composition can also perform operations on the composition to determine whether or not there are any errors or structural faults with the composition as written by the user.

The planner 406 can transmit the instructions created from the composition to a builder. The builder at step 408 can take the instructions and build, update, or destroy the infrastructure specified by the user in the specified cloud.

At step 410, the cloud can run the infrastructure specified by the builder in step 408. As the cloud is running the specified infrastructure, should any errors occur in the operation of the infrastructure, the cloud can notify a watcher algorithm at step 412 which can then trigger a rebuild at the handler step 404 of the components of the infrastructure that have generated the error.

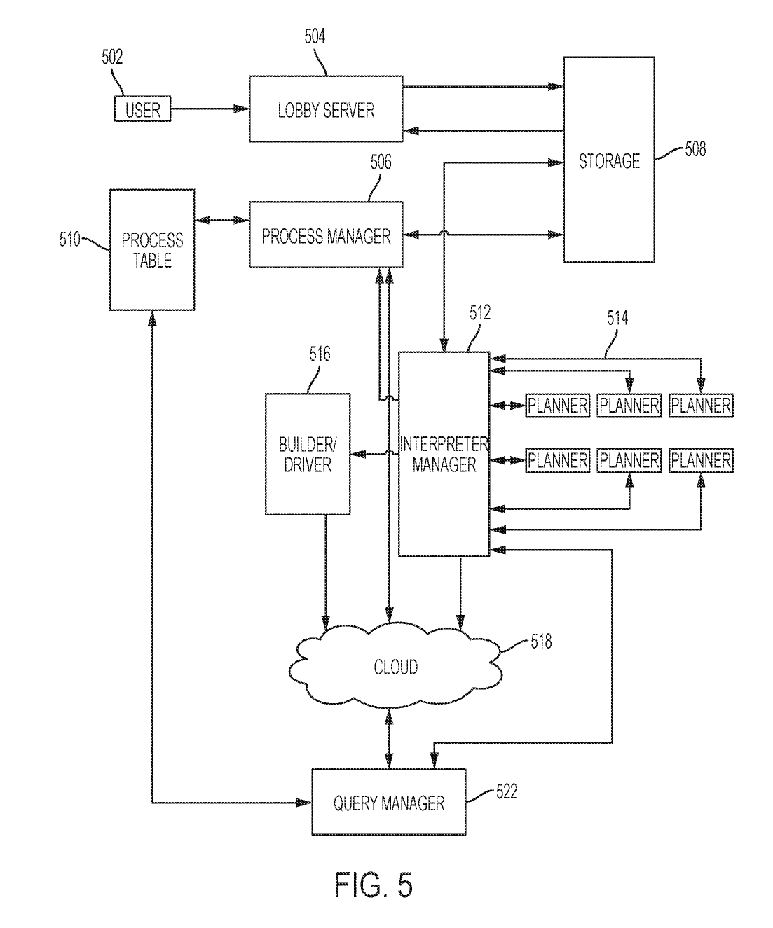

FIG. 5 illustrates an exemplary cloud environment operating system functional block diagram according to examples of the disclosure. The functional block diagram illustrated in FIG. 5 can, in some examples, implement the process described in FIG. 4.

Block 502 can represent the user process that occurs before operation of the cloud environment operating system as described above with respect to FIGS. 1-3. As previously discussed, the user can declare an infrastructure using user-friendly syntax which can then be converted to a lower level language that can be interpreted by the cloud environment operating system to build a desired infrastructure on the cloud. User 502 can represent one user, or in some examples can represent multiple users, each of which has specified a desired computing infrastructure to be implemented on a cloud, or multiple clouds.

Block 504 can represent a lobby server. Lobby server 504 can receive low level code (otherwise known as a command line interface) from one or more users and performs a “pitch and catch process” that receives code from one or more users and unpacks it (i.e., distill the parts of the code that will interface with the cloud environment operating system) and stores any data (at storage unit 508) that is needed to compile the code and routes the information that comes from the user to the appropriate modules within the cloud environment operating system. In addition, the lobby server 504 can identify all of the processes associated with a particular user's command line interface and apply process “tags” to those processes. The process tags can allow the cloud environment operating system to track where in the system the processes are currently being executed. This feature can allow for simplicity in scheduling management as will be discussed further below.

The lobby server 504 can also handle external data requests. If a request is made to the cloud environment operating system for certain forms of data about the run-time environment of the cloud environment operating system, the lobby server 504 is able to receive the request, execute it, and send the acquired data to the appropriate stake holder.

Once the code received from the user has been processed by the lobby server 504, the processed code can then be sent to process manager 506. The process manager 506 can manage a process table 510 which lists each and every process to be run by the cloud environment operating system. In other words, one set of instructions to build a particular infrastructure by a particular user can be handled as a process. Another set of instructions to build infrastructure by another user can be handled as a separate process. The process manager 506 can manage each separate user's tasks as a processes within the system by assigning it a process ID and tracking the process ID through the system. Each user's individual tasks to be executed by the cloud environment operating system can be managed as separate entities. In this way, the process manager 506 can enable the cloud environment operating system to operate as a “multi-tenant” system as opposed to a single-user system. In other words, multiple users can implement multiple computing environments via single instance of a cloud environment operating system. The cloud environment operating system can handle requests for infrastructure from multiple users simultaneously rather than being dedicated to a single user or single machine.

In addition to the functions described above, the process manager 506 can also perform status checks on the implementation of the infrastructure in the cloud. In pre-determined time intervals, the process manager 506 can initiate a process whereby a signal is sent to the query manager 522 to determine the status of the infrastructure in the cloud. The query manager 522 can determine the status of the user's infrastructure and send commands to the interpreter manager 512 to take action (described further below) if it is determined from the query manager that the user's infrastructure specification does not match infrastructure present on the cloud.

Once the process manger identifies the process to be executed on the cloud environment operating system and stores the processes on process table 510, it can then send those processes to the Interpreter Manager 512 to be converted into a set of instructions that can ultimately be executed by the cloud.

The interpreter manager 512 can be responsible for converting the user's command line interface language (i.e., high level declaration) into a series of specific instructions that can be executed by the cloud environment operating system. The interpreter manager 512 can achieve this by employing a series of planning modules 514 that accept, in some examples, resource tables at its input and generates resource tables in which any omissions in the syntax provided by the user are filled in. The interpreter manager 512 can review a resource table sent by the user and send it to the series of planning modules 514 based on what infrastructure needs have been declared by the user. The planning modules 514 alter the user's resource table and return it to the interpreter manager 512. This process may be repeated with other planning modules until the final correct version of the resource table is complete. The interpreter manager 512 then converts the resource table into a machine instruction file which can be referred to as a low level declaration of the computer infrastructure to be built on the cloud. The low level declaration is then sent to the builder/driver 516 (discussed in detail below).

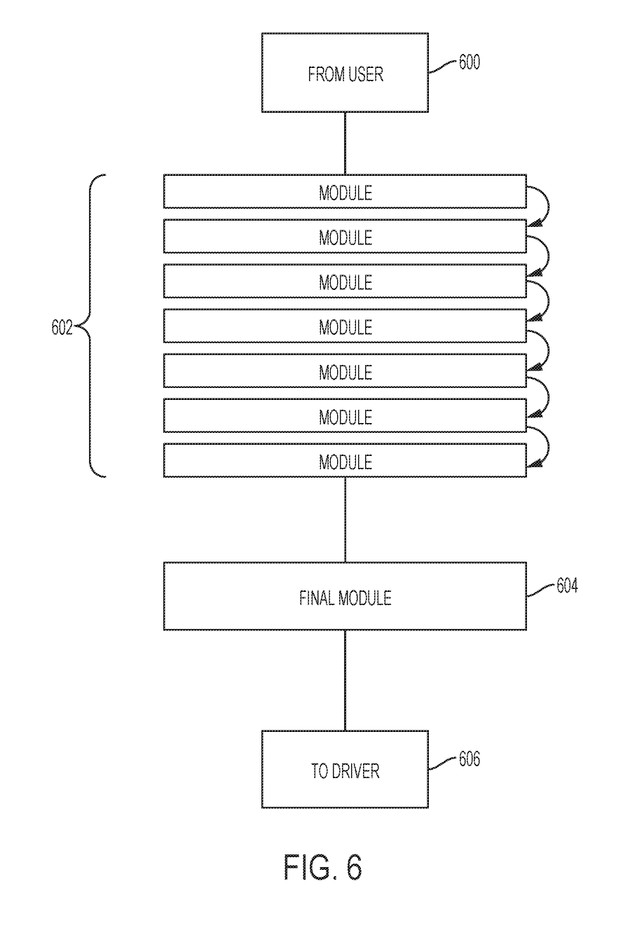

FIG. 6 illustrates an exemplary planning module process according to examples of the disclosure. As previously discussed with respect to FIG. 5, interpreter manager 512 can include multiple planning modules 602. Each planning module 602 can be responsible for handling specific types as defined in the programming syntax used by the user to specify their desired infrastructure. As an example, if a user specifies that they want a load balancer as part of their infrastructure, a specific planning module within the interpreter manager 512 can be assigned responsibility for handing load balancer types and can convert the specification of a load balancer by the user into instructions to be implemented on a cloud.

Each planning module 602 can accept at its input the code received by the user 600 expressed a resource table, and can return a resource table that is more specific and complete filling in any omissions in the resource table that were present when it was inputted. In one example, the code from the user is input into a first planning module 602 that returns a resource table that is then inputted into a second module. The output of the second module is then inputted into a third module, etc., etc.

The use of modules to convert a user's command line interface language into instructions for a cloud can also allow for ease in defining new types of infrastructure previously not available on the cloud environment operating system. In one example, if a load balancer was not an infrastructure type supported by the cloud environment operating system, a user could simply create a library in the programming language on the user side that supports the declaration of a load balancer. In order for the cloud environment operating system to support the “new” load balancer, a new module could be created that provides the logic for handling load balancer infrastructure types. In this way, the modular nature of the interpreter manager 512 allows for ease in adding new infrastructure types.

Returning to FIG. 6, the multiple modules 602 can, in one example, be arranged in a pipeline/stacked configuration. When code is sent by a user 600 as previously discussed, the interpreter manager 512 can process the code by running through each module individually. In other words, the code can be passed from module to module until it has passed through each and every module of the interpreter manager 512.

The order in which the code is processed through the modules 602 can vary. For instance in one example, the code can be processed sequentially through each module in a pre-defined order. In another example, the code can be processed in an order that depends on dependencies between the modules 602. For instance, one module may depend on the result of another module before it can process the code. In this instance, the module that is dependent on the result of another module can wait until completion of the module it is dependent on to finish before beginning its' processing.

After the code provided by the user is processed through the modules 602, it can finally be sent to a final module 604 for final processing. Final module 604 can be responsible for finalizing the resource table to be prepared for conversion into a series of instructions that can be understood by the cloud. Ultimately the pipeline of modules 602 and 604 create a low level code that is free from the abstractions and omissions previously present at the higher level language provided by the user. Finally, module 604 can also determine whether all of the abstractions and omissions have been resolved by the modules 602. If it is determined that not all omissions and abstractions have been resolved, final module 604 can run the resource tables back through the modules and repeat the process until each and every resource table has been completed.

In addition to a language interpretation function, in which the modules 602 interpret language from a user into a lower level language to be executed by the cloud, each module can also perform one or more run-time operations. As an example, the modules can run a de-bugging operation. When a high level declaration is received from a user, a dry run through the modules can be performed in which the code is run through module-by-module to ensure that there are no errors in the code such as those caused by typos or other operator error. If an error is found, the interpreter manager 512 can notify the user of the error.

In contrast, a cloud environment operating system without this capability would instead parse the code from the user and pass a series of instructions to the cloud. Once the cloud begins to implement the series of instructions, it may then encounter an error and ultimately not generate the desired infrastructure. The user may not become aware of the error until much later in the process which can waste time and resources. Instead the cloud environment operating system, through the interpreter manager 512, can detect these errors earlier in the process chain such that they can be corrected further upstream in the process.

Another example of a run-time operation performed by the modules is that each module is able to communicate to resources external to the cloud environment operating system in order to resolve omissions and abstractions from the user's code. For instance in one example, if the user level code requires the most update-to-date version of a component of the infrastructure, the modules 602 can communicate with an external configuration management system to provide that up-to-date component.

The planning modules 514 discussed above can adjust a user's infrastructure in response to conditions of the infrastructure after it has already been implemented on the cloud. As discussed above, process manager 506, after a pre-defined time period, can query the status of the infrastructure via a query manager 522. The status of the infrastructure can then be sent by the process manager to interpreter manager 512. Interpreter manager 512, via the planning modules 514, can compare the specification of the infrastructure as specified by the user with the current status of the infrastructure. If a difference is found between the specification of the infrastructure by the user and its current state on the cloud, the planning modules 514 can generate code to correct the infrastructure on the cloud so that it conforms to what the user specified.

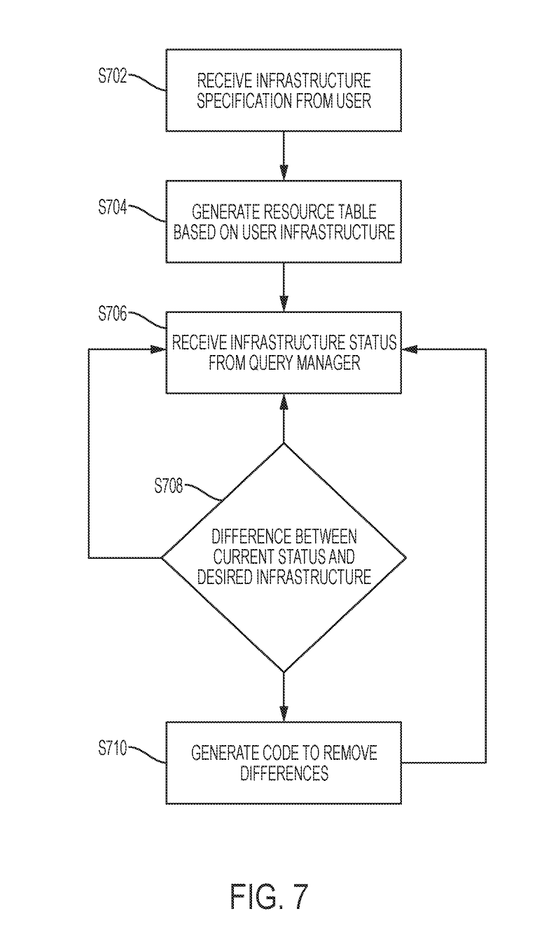

FIG. 7 illustrates an exemplary infrastructure maintenance process according to examples of the disclosure. The process outlined in FIG. 7 can be, in some examples, implemented in the interpreter manager 512 that utilizes the planning modules 514. At step S702 the interpreter manger 512 can receive a declaration of infrastructure from a user as discussed above.

At step S704 the interpreter manager 512 can generate a completed resource table based on the specified infrastructure to be built by the user. As will be discussed further below, the completed resource table can be sent to a Builder/Driver 516 to be converted into a series of instructions that will be executed by the cloud.

At step S706, the interpreter builder 512 can receive a status of the infrastructure already built from query manager 522. As discussed above, query manager 522 can be prompted by the process manager 506 in pre-determined time intervals to return a status of the infrastructure.

At step S708 the interpreter manager 512 can compare the current status of the infrastructure on the cloud as provided by the query manager 522 with the declaration of the infrastructure provided by the user at S702. If there are no differences between the declared infrastructure and the current status of the infrastructure, the process can return to step S706 to await the next status update from the query manager 522.

If however, there is a difference between the current status of the infrastructure, the planning modules 514 of interpreter manager 512 can be employed to generate resource table updates that can be passed to the cloud via builder/driver 516 so as to ensure that the infrastructure on the cloud is conformed to the original declaration of the infrastructure by the user.

Once the infrastructure on the cloud has been modified according the user's declaration, the process can return to the step S706 to await the next status update from the query manager 522.

In this way, not only does the cloud environment operating system build a desired infrastructure on a cloud, it also continually checks the infrastructure to ensure that there has not been any configuration drift or corruption over time that would bring the infrastructure out of specification with what the user initially declared the structure to be. This feature can provide an improvement over conventional cloud operation systems that implement a user's infrastructure but do not monitor that infrastructure for configuration drift or corruption over time.

Returning to FIG. 5, once the interpreter manager 512 completes its processes as described above, it can send a completed resource table to builder/driver 516. Builder/driver 516 can convert the completed resource table into a series of instructions that can be executed by the cloud. The builder/driver 516 can interface with the application program interface (API) of the cloud 518 to generate the desired infrastructure, or the desired modifications of the infrastructure as described above.

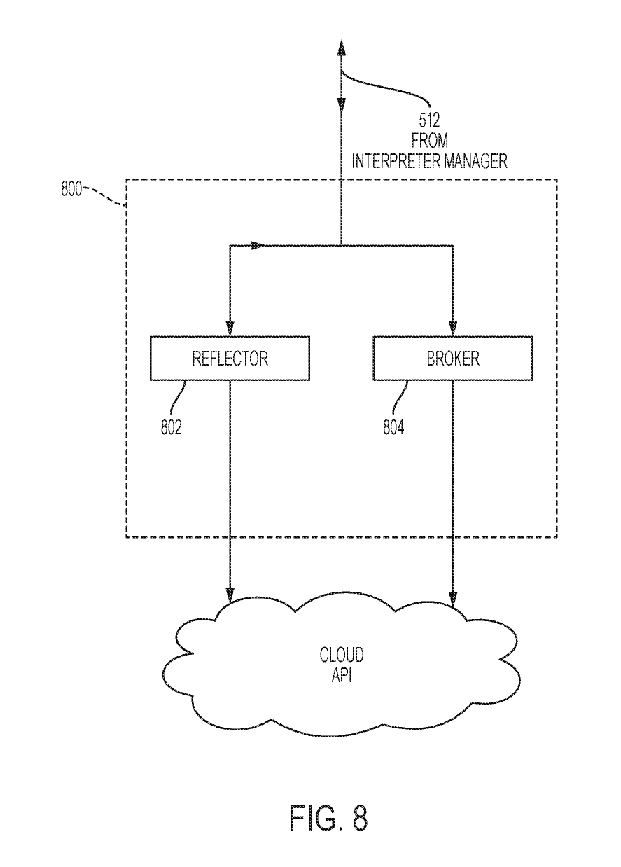

FIG. 8 illustrates an exemplary builder/driver unit according to examples of the disclosure. The builder/driver 800 can include a reflector unit 802 as well as a broker unit 802. The broker unit 802 can be responsible for generating all of the “write” commands to the cloud service provider's API so as to create, destroy, or modify computing infrastructure implemented on the cloud computing environment. When a user wishes create new instances of computing infrastructure on the cloud, modify existing instances of computing infrastructure on the cloud environment, or wishes to destroy existing instances of computing infrastructure on the cloud environment, the broker 804 can generate the commands that are to be received by the cloud service provider's API in order to implement the user's desired operation.

The reflector 802 can be responsible for generating all of the “read” commands to the cloud service provider's API so as to generate information regarding the current state of the computing infrastructure that is already implemented on the cloud. The reflector 802 can interface with the an interpreter/manager unit 512 (described above with respect to FIG. 5) so as to allow the planner modules 514 to get a current status of the exiting computing infrastructure on the cloud.

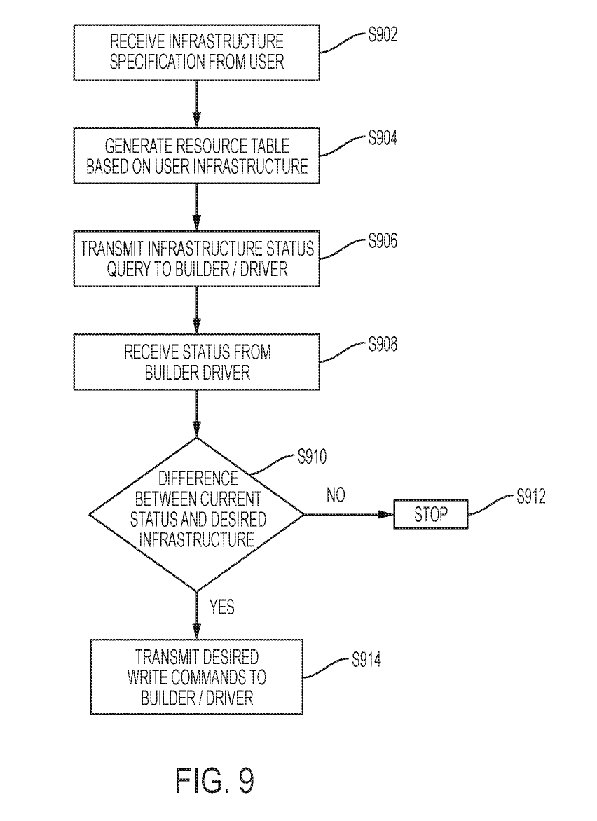

FIG. 9 illustrates an exemplary infrastructure building process according to examples of the disclosure. The process outlined in FIG. 9 can be, in some examples, implemented in the interpreter manager 512 that utilizes the planning modules 514 as well as the builder/driver 516 discussed above with respect to FIGS. 5 and 8. At step S902, the interpreter manger 512 can receive a declaration of infrastructure from a user as discussed above.

At step S904, the interpreter manager 512 can generate a completed resource table based on the specified infrastructure to be built by the user. As will be discussed further below, the completed resource table can be sent to a Builder/Driver 516 to be converted into a series of instructions that will be executed by the cloud.

At step S906, the interpreter manager 512 can transmit an infrastructure status query to Builder/Driver 516. An infrastructure status query can refer to a query by the interpreter manager 512 as to the current status of the existing computing infrastructure that exists on the cloud. The reflector 802 of builder/driver 516 can field the infrastructure status query from the interpreter manager 512 and return a status of the currently existing computing infrastructure on the cloud.

At step S908, the interpreter manager 512 can receive the results of the infrastructure status query made at step S906 from the builder/driver 516 and more specifically from the reflector unit 802 located within the builder/driver 516.

At step 910, the interpreter manager can determine if there are any differences between the current status of the computing infrastructure on the cloud gleaned from the results of the infrastructure status query and the desired infrastructure received at step S902. As an example, if the user desires a total of 5 servers in their computing infrastructure environment, and as a result of an infrastructure query the interpreter manager 512 determines that 4 servers already exist, then the interpreter manager can determine that a total of one server needs to be built onto the existing computing infrastructure in order to fulfill the user's desired computing infrastructure.

If there is no difference between the user's desired infrastructure and the currently existing infrastructure on the cloud, then the process can move to step S912 and terminate. However, if there is a difference, the process can move to step S914 wherein the interpreter manager 512 can send the desired infrastructure to be built (that doesn't already currently exist) to Builder/Driver 516 to issue the write commands to the cloud service provider's API. More specifically, the broker 804 of the builder/driver 516 can generate the write commands and transmit them to the cloud service provider's API for processing.

As discussed above, the reflector 802 and the broker 804 can issue commands to the cloud service provider's API to read from or write to the cloud computing environment respectively. However, a particular cloud service provider's API can have a limit imposed on it as to how many commands it can process at any given time. This limit (i.e., the throttle limit) can restrict any particular user of a cloud service provider to limited number of commands that they can issue at any given time.

The throttle limit can be imposed by cloud service provider so as to ensure that each user of the service experience a high quality of service. In one example, if a particular issues a high number of computationally expensive requests simultaneously to the cloud service provider, other users of the cloud service provider may experience delays in processing while the cloud service provider is engaged with the numerous requests from a single user. The throttle limit can prevent a single user from monopolizing the cloud service provider's computational resources at any given time. Throttle limits can also be employed by cloud service provider's to prevent malicious users from attacking a particular cloud computing environment. As an example, a malicious user may try issues a denial-of-service (DoS) attack wherein the user issues numerous commands to the cloud's API in an attempt to frustrate the broader user population's quality of service in fielding their requests to the cloud service provider.

A substantial number of cloud service provider's such as Amazon Web Services or Microsoft's Azure cloud environment do not publish their API throttle limits. Therefore users of the cloud service provider, or cloud operating systems that can act as an interface between a user and a cloud service provider, do not know how many commands they can issue to a cloud service provider's API before the throttle limit is tripped.

Furthermore, the API throttle limit for a particular cloud service provider can change at any given time. For instance at one particular point in time the cloud service provider could set the API throttle limit to 10 commands per second, and at another point in time the cloud service provider could set the API throttle limit to 7 commands per second. For instance if a cloud service provider is experiencing an outage of service at any particular time in a specific region, they may elect to lower the API throttle limit of all of its users since there are now less computing resources available to field write and read commands from various users.

The consequences of tripping a cloud service provider's API can lead to substantial problems for a user of a cloud computing environment. Many cloud service providers will severely limit an individual user's ability to issue commands to the API if they violate the API throttle limit. For instance if the API throttle limit for a particular cloud service provider is 25 commands per second, and a user during a particular second issues 28 commands, the cloud service provider may flag their account and lower the amount of commands a particular user can issue per second over a pre-determined duration of time. Using the example above, if the API throttle limit is 25 commands per second and a particular user attempts to issue 29 commands to the API during a given second, the cloud service provider can flag their account as being overly aggressive and limit that user to 10 commands per second during a 40 minute time period. During this 40 minute time period, the user may experience a diminished throughput because its ability to issue commands to the API is now severely restricted. This diminished throughput can effect an entire business organization if the entire organization utilizes a single user account to implement their computing infrastructure on the cloud.

Thus, if a user attempts to send too many commands to the API during a given time, the user will get notified by the web service that it has reached the throttle limit and subsequent requests may get denied by the cloud service provider because the individual user's account is restricted as to how many commands it can issue at a given time.

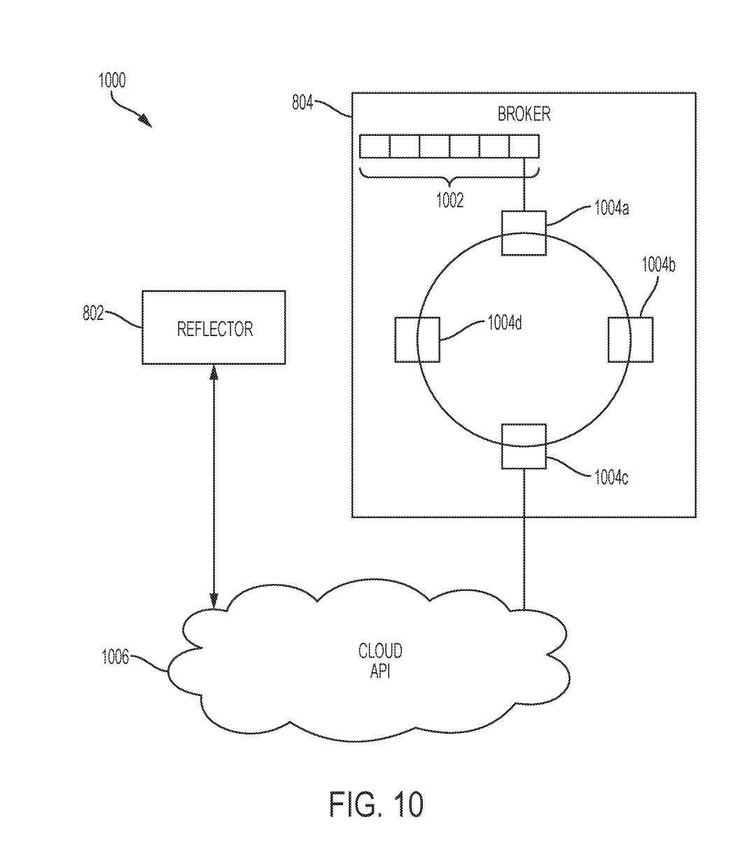

In order to avoid tripping the API throttles of various cloud service providers, a cloud computing operating system can implement a request queuing system in order to limit the number of requests that are being issued to a cloud service provider at a given time. FIG. 10 illustrates an exemplary cloud operating system queuing system according to examples of the disclosure. In the system 100, the broker 804 (of FIG. 8) can include a queue 1002. Queue 1002 can store commands that are to be issued to the cloud API and that are generated by the broker 804 in response to requests from the interpreter manager 512 and queue them in a first in-first out manner. The broker 804 can also include a plurality of worker modules 1004a-d. In the example of FIG. 10, there are 4 worker modules illustrated however the number of worker modules in FIG. 10 is for illustration purposes, and the broker 804 can be implement with more or less worker modules.

Each worker module 1004a-d can load a pre-determined number of commands stored in queue 1002 and then interface with cloud API 1006 to implement those commands. Once the worker module is finished implementing the command on the cloud API 1006, the worker module can return to the queue 1002 to receive more commands from the queue for implementation on the cloud service provider API 1006. In this way, by limiting the number of commands a single worker can run on a cloud service API 1006 at a given time, and allowing only one worker to interface with the API at a given moment, the number of commands issued to the cloud service API at a given time can be controlled and metered.

The reflector 802 can interface with the cloud service API using a single threaded approach. In other words, the reflector 802 can issue a single command to the cloud at any given time. Thus the user account as a whole can be limited to the number of commands that a single worker can implement at a given time plus one (the number of commands that the reflector can issue at a given moment). Thus, since the broker and the reflector can have the total number of commands that are issued to the cloud service provider's API, the broker and the reflector can be asynchronously managed. In other words, the broker and the reflector can issue commands to the API independent of one another.

The pre-determined number of commands that a particular worker module should handle can be based on a desire to not trip the API throttle limit of a particular cloud service provider. In one example, the number of commands that a particular worker module should handle at a given time can be empirically determined. The cloud operating system provider can run a series of test cases in which a varying amount of commands are issued to the cloud service provider's API to determine when the API throttle is tripped, thereby estimating the API throttle limit. As discussed above, the API throttle can vary depending on the time of day or service outages, so the cloud service provider can run their tests at different times of day and over a large period of time to arrive at a maximum number of commands in which the API throttle will be virtually guaranteed not to be tripped.

In one example, if the number is determined to be 25 commands in a second, then the worker modules 1004a-d can be configured to load up to 24 commands from the queue 1002 at a given time (allowing for the reflector 802 to have one command to itself since it can be implemented as a single threaded interface with the cloud API). In this way, at any given moment, the cloud operating system of a particular system will issue a maximum of 25 commands and be virtually guaranteed to not trip the API throttle of a particular cloud service provider.

In one example, the maximum number of commands can be determined empirically once and for the duration of the operation of the cloud operating system, the worker module will have a maximum number of commands it can implement at a given time permanently set. In another example, the empirical determination can be periodically refreshed and the maximum number of commands that the worker can implement can be dynamically adjusted if it is determined that the API throttle has changed.

The optimal number of workers can also be empirically determined. If there are too many worker modules, then too many commands may be sent to the cloud API at a given time thereby tripping the API throttle. The number of workers can be what controls the number of instructions being issued to the cloud service API. The number of workers can be set to the maximum throughput of the cloud service API. Each worker can then issue a single instruction to the API at a time. Take together, each worker issues a single command can add up to just less than the API throttle limit set by the cloud service provider.

In another example, lobby server 504, process manager 506, storage 508, process table 510, interpreter manager 512, planner modules 514, builder driver 516, and query manager 522 can be implemented within a cloud computing environment in which case, rather than interfacing with a cloud 518, the system interfaces with a computing environment located within the cloud or another cloud service provider external to the cloud computing environment in which the above mentioned components reside (see further discussion below). In some embodiments, a cloud computing environment can include a separate account created in a cloud service provider by the cloud computing environment to implement a user-specified computing environment.

In addition to monitoring the implementation of the declared infrastructure on the cloud, the system described in FIG. 5 can also conduct policy checking functionality. As an example, if the cloud service has specific policies with regard to such things as network security, communication protocols, etc., and the user's declared infrastructure violates any of the policies of the cloud, the user can be notified of such violation prior to any infrastructure being built on the cloud.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

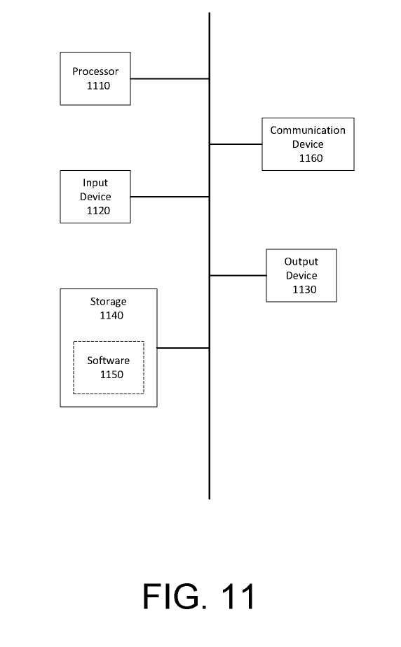

FIG. 11 illustrates an example of a computing device in accordance with one embodiment. Device 1100 can be a host computer connected to a network. Device 1100 can be a client computer or a server. As shown in FIG. 11, device 1100 can be any suitable type of microprocessor-based device, such as a personal computer, work station, server, or handheld computing device (portable electronic device) such as a phone or tablet. The device can include, for example, one or more of processor 1110, input device 1120, output device 1130, storage 1140, and communication device 1160. Input device 1120 and output device 1130 can generally correspond to those described above, and can either be connectable or integrated with the computer.

Input device 1120 can be any suitable device that provides input, such as a touchscreen, keyboard or keypad, mouse, or voice-recognition device. Output device 1130 can be any suitable device that provides output, such as a touchscreen, haptics device, or speaker.

Storage 1140 can be any suitable device that provides storage, such as an electrical, magnetic, or optical memory including a RAM, cache, hard drive, or removable storage disk. Communication device 1160 can include any suitable device capable of transmitting and receiving signals over a network, such as a network interface chip or device. The components of the computer can be connected in any suitable manner, such as via a physical bus, or wirelessly.

Software 1150, which can be stored in storage 1140 and executed by processor 1110, can include, for example, the programming that embodies the functionality of the present disclosure (e.g., as embodied in the devices described above).

Software 1150 can also be stored and/or transported within any non-transitory, computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction-execution system, apparatus, or device.

Software 1150 can also be propagated within any transport medium for use by or in connection with an instruction-execution system, apparatus, or device, such as those described above, that can fetch instructions associated with the software from the instruction-execution system, apparatus, or device and execute the instructions. In the context of this disclosure, a transport medium can be any medium that can communicate, propagate, or transport programming for use by or in connection with an instruction-execution system, apparatus, or device. The transport readable medium can include, but is not limited to, an electronic, magnetic, optical, electromagnetic, or infrared wired or wireless propagation medium.

Device 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A method for building computing infrastructure on a cloud computing system operated by a cloud service provider, the cloud service provider providing service to a plurality of users, the cloud computing system having an application program interface (API) that limits the number of instructions that each user of the cloud service provider can execute during a pre-determined time period, the method comprising:
determining an estimated API throttle limit;
determining a maximum instructions limit based on the determined estimated API throttle limit, wherein the maximum instructions limit is less than the estimated API throttle limit;
transmitting the maximum instructions limit to a user of the cloud service provider;
executing by the user one or more instructions on the cloud computing system to build the computing infrastructure, wherein executing the one or more instructions on the cloud computing system comprises:
placing the one or more instructions into a queue; and
transmitting a set of the one or more instructions in the queue to an API of a cloud service provider for execution on the cloud service provider, wherein the number of instructions in the set is less than or equal to the maximum instructions limit.

2. The method of claim 1, wherein determining an estimated API throttle limit includes:
executing a plurality of instructions on the API until the API throttle limit is reached.

3. The method of claim 1, wherein determining an estimated API throttle limit includes:
executing a plurality of instructions on the API during a plurality of pre-determined times during a day and determining each time when the API throttle limit is reached.

4. The method of claim 1, wherein the maximum instructions limit is based on determining the number of instructions below the estimated API throttle limit that can be sent to the API so as to minimize a number of instructions that are rejected by the API for exceeding the API throttle limit.

5. The method of claim 1, wherein the determination of the maximum instructions limit is conducted each time that the estimated API throttle limit is changed.

6. The method of claim 1, wherein executing the one or more instructions on the cloud computing system includes executing one or more write operations and executing one or more read operations on the API of the cloud service provider.

7. The method of claim 6, wherein the read operations are executed on the API of the cloud service provider using a single-threaded approach.

8. The method of claim 6, wherein the write operations are executed on the API of the cloud service provider using a multi-threaded approach.

9. The method of claim 6, wherein a number of instructions executed on the API of the cloud service provider is apportioned between the write operations and the read operations.

10. The method of claim 6, wherein the write operations and the read operations are executed asynchronously with respect to one another.

11. A non-transitory computer readable storage medium storing one or more programs, the one or more programs comprising instructions for building computing infrastructure on a cloud computing system operated by a cloud service provider, the cloud service provider providing service to a plurality of users, the cloud computing system having an application program interface (API) that limits the number of instructions that each user of the cloud service provider can execute during a pre-determined time period, which when executed by a portable electronic device, cause the device to:
determine an estimated API throttle limit;
determine a maximum instructions limit based on the determined estimated API throttle limit, wherein the maximum instructions limit is less than the estimated API throttle limit;
transmit the maximum instructions limit to a user of the cloud service provider;
execute by the user one or more instructions on the cloud computing system to build the computing infrastructure, wherein executing the one or more instructions on the cloud computing system comprises:
place the one or more instructions into a queue; and
transmit a set of the one or more instructions in the queue to an API of a cloud service provider for execution on the cloud service provider, wherein the number of instructions in the set is less than or equal to the maximum instructions limit.

12. The non-transitory computer readable medium of claim 11, wherein determining an estimated API throttle limit includes:
executing a plurality of instructions on the API until the API throttle limit is reached.

13. The non-transitory computer readable medium of claim 11, wherein determining an estimated API throttle limit includes:
executing a plurality of instructions on the API during a plurality of pre-determined times during a day and determining each time when the API throttle limit is reached.

14. The non-transitory computer readable medium of claim 11, wherein the maximum instructions limit is based on determining the number of instructions below the estimated API throttle limit that can be sent to the API so as to minimize a number of instructions that are rejected by the API for exceeding the API throttle limit.

15. The non-transitory computer readable medium of claim 11, wherein the determination of the maximum instructions limit is conducted each time that the estimated API throttle limit is changed.

16. The non-transitory computer readable medium of claim 11, wherein executing the one or more instructions on the cloud computing system includes executing one or more write operations and executing one or more read operations on the API of the cloud service provider.

17. The non-transitory computer readable medium of claim 16, wherein the read operations are executed on the API of the cloud service provider using a single-threaded approach.

18. The non-transitory computer readable medium of claim 16, wherein the write operations are executed on the API of the cloud service provider using a multi-threaded approach.

19. The non-transitory computer readable medium of claim 16, wherein a number of instructions executed on the API of the cloud service provider is apportioned between the write operations and the read operations.

20. The non-transitory computer readable medium of claim 16, wherein the write operations and the read operations are executed asynchronously with respect to one another.
